(19) United States
(12) Patent Application Publication
(10) Pub. No.: US 2013/0172512 A1
(43) Pub. Date: Jul. 4, 2013

(54) BIO-BASED POLYURETHANE ARTICLE

(71) Applicant: Everest Textile Co., Ltd., Tainan City (TW)

(72) Inventors: Huang-Shan Lin, Tainan City (TW); Hsin-Hung Lin, Tainan City (TW); Chuan-I Hsu, Tainan City (TW); Cheng-Hao Tsai, Tainan City (TW)

(73) Assignee: EVEREST TEXTILE CO., LTD., Tainan City (TW)

(21) Appl. No.: 13/733,385

(22) Filed: Jan. 3, 2013

(30) Foreign Application Priority Data
Jan. 4, 2012 (TW) 101100314

(51) Int. Cl. C08G 18/28

(52) U.S. Cl. CPC C08G 18/28
USPC 528/66

(57) ABSTRACT

A polyurethane article includes at least 25% of bio-based content and is made of a reactive composition containing an isocynate compound, a polymeric polyol component including biomass derived polymeric polyol, and a biomass derived diol.

### CROSS-REFERENCE TO RELATED APPLICATION

This application claims priority of Taiwan Patent Application No. 101100314, filed on Jan. 4, 2012.

### BACKGROUND OF THE INVENTION

1. Field of the Invention

This invention relates to a polyurethane article, more particularly to a polyurethane article including bio-based content.

2. Description of the Related Art

Due to environmental concerns and dramatically increased cost of petroleum feedstocks, many researches have focused on finding renewable resources that are capable of reducing use of fossil fuels. Bio-based materials which contain raw materials derived from biological resources (so called biomass) instead of resources derived from fossil fuels are considered “green” and “eco-friendly”, and 25% of bio-based content is considered as a standard for a Low-Carbon material. Conventional polyurethane articles are made of chemicals derived from petroleum feedstocks which cause environmental damage. Therefore, there is a need in the art to provide a polyurethane article made of bio-based materials.

### SUMMARY OF THE INVENTION

Therefore, the object of the present invention is to provide a polyurethane article including at least 25% of bio-based content.

According to this invention, a polyurethane article includes at least 25% of bio-based content and is made of a reactive composition containing an isocynate compound, a polymeric polyol component including biomass derived polymeric polyol, and a biomass derived diol.

### BRIEF DESCRIPTION OF THE DRAWING

Other features and advantages of the present invention will become apparent in the following detailed description of the preferred embodiment of this invention, with reference to the accompanying drawing, in which:

FIG. 1 is a flow chart describing a manufacturing process of a preferred embodiment of a polyurethane article according to the present invention.

### DETAILED DESCRIPTION OF THE PREFERRED EMBODIMENT

This invention provides a polyurethane article that includes at least 25% of bio-based content and that is made of a reactive composition including an isocynate compound, a polymeric polyol component including biomass derived polymeric polyol, and a biomass derived diol as a chain extender.

Preferably, the reactive composition includes, based on the total weight of the reactive composition, 35 wt % to 36 wt % of the isocynate compound, 52 wt % to 59 wt % of the polymeric polyol component, and 8 wt % to 10 wt % of the biomass derived diol.

Preferably, the polymeric polyol component includes 17 wt % to 20 wt % of the biomass derived polymeric polyol and 35 wt % to 39 wt % of polyethylene glycol (PEG) based on the total weight of the reactive composition. Preferably, PEG has a molecular weight ranging from 3000 to 6000. The weight percentage of PEG is related to the moisture permeability of the polyurethane article. When the weight percentage of PEG is increased, the polyurethane article exhibits higher moisture permeability but sacrificing the tensile stress thereof. In contrast, when the weight percentage of the PEG is decreased, the polyurethane article has lower moisture permeability but exhibiting higher tensile stress thereof.

Examples of the biomass derived polymeric polyol are selected from the group consisting of polypropylene glycol, poly(propylene glycol adipate) diol, and the combination thereof. Preferably, the biomass derived polymeric polyol has a molecular weight ranging from 1000 to 2400.

When the weight percentage of the isocynate compound is higher than 36% based on the total weight of the reactive composition, the resultant polyurethane article is relatively hard and lacks of elasticity. When the weight percentage of the isocynate compound is lower than 35%, the polyurethane article has insufficient tensile strength and easily breaks. Preferably, the isocynate compound is methyl diphenyl diisocyanate.

Preferably, the biomass derived diol is ethylene glycol. More preferably, the biomass derived diol includes more than 95 wt % of ethylene glycol, and less than 5 wt % of at least one of propanediol and butanediol based on the weight of the biomass derived diol. When the weight percentage of the biomass derived diol is higher than 10 wt % based on the total weight of the reactive composition, the polyurethane article is relatively hard and lacks elasticity. When the weight percentage of the biomass derived diol is lower than 8 wt %, the polyurethane article has insufficient tensile strength and breaks easily.

The reactive composition of the polyurethane article may further include additives. The additives includes, for example, a catalyst that is lower than 0.5 wt % based on the reactive composition, an antioxidant that is lower than 0.2 wt % based on the reactive composition, and a viscosity reducer that is lower than 0.6 wt % based on the reactive composition.

Preferably, the polyurethane article is configured as a film shape. A manufacturing process for producing a polyurethane film includes mixing 100 parts by weight of a polyurethane product which is made from the reactive composition and that has 35% of solid contents, 2 to 5 parts by weight of an anti-adhesive, lower than 0.3 part by weight of a leveling agent, lower than 0.3 part by weight of an anti-yellowing agent, and higher than 42 parts by weight of a solvent to form a mixture having viscosity ranging from 3500 to 5000 cps, distributing the mixture on a release film, drying the mixture in an oven, and then aging at room temperature to obtain the polyurethane film having at least 25% of bio-based content. Examples of the solvent include, but are not limited to, dimethyl formamide, dimethyl benzanthracene, methyl-ethyl ketone, and combinations thereof.

### EXAMPLE

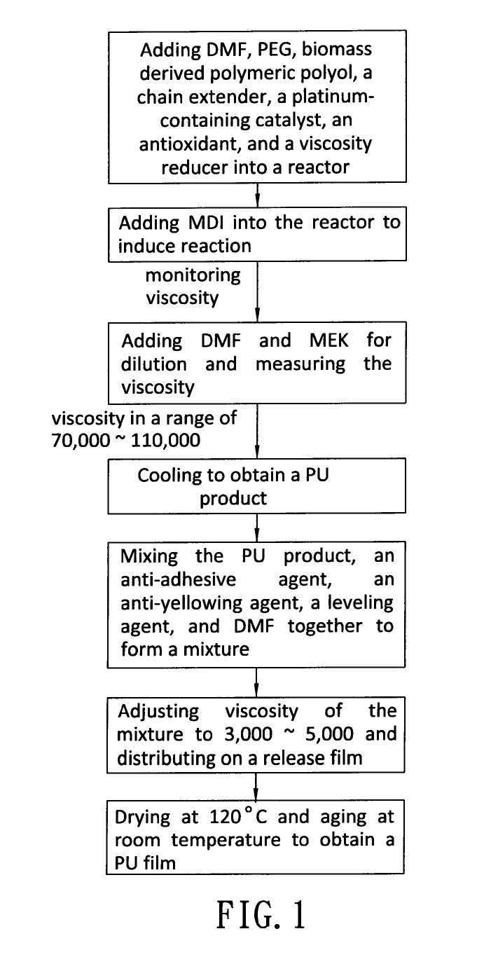

FIG. 1 shows a process for manufacturing the preferred embodiment of a polyurethane article according to the present invention. A formula of a reactive composition used in this process is presented in Table 1.

TABLE 1

| Formula | weight % |
|---|---|
| methyl diphenyl diisocyanate | 35 |
| biomass derived diol* | 9 |
| polyethylene glycol | 35 |
| biomass derived polypropylene glycol | 19 |
| platinum containing catalyst | 0.3 |
| antioxidant | 0.2 |
| viscosity reducer | 0.5 |

*The biomass derived diol includes 95 wt % of ethylene glycol and 5 wt % of a mixture including 2,3-butanediol, 1,2-butanediol, and 1,4-butanediol based on total weight of the biomass derived diol. The density of the biomass derived diol is 1.071 g/cm³ at 20° C.

First, the reactive composition was added into a reactor along with a sufficient amount of dimethyl formamide (DMF) to form a primary mixture, followed by agitating the primary mixture for 30 minutes. Then, methyl diphenyl diisocyanate (MDI) was divided into two portions, and a first portion of diphenyl diisocyanate was added sequentially into the primary mixture with stirring for an hour to induce a reaction and a second portion of diphenyl diisocyanate was added sequentially thereafter to continue the reaction. The reaction temperature was controlled in a range from 70° C. to 75° C. for the first hour and was controlled in a range from 84° C. to 86° C. for the rest of the reaction time. Viscosity of the reactants was monitored during the whole reaction, and dimethyl formamide (DMF) may be added into the reactor if the viscosity of the reactants is higher than a predetermined value. At the end of the reaction, dimethyl formamide (DMF) and methyl-ethyl ketone (MEK) were added into the reactor to adjust the viscosity in a range from 70,000 to 110,000 cps, followed by cooling to obtain a polyurethane product.

In this example, the ratio of DMF and MEK is 9:1, and the polyurethane product has 35% of solid content and viscosity of 87,000 cps.

100 parts by weight of the polyurethane product, 4 parts by weight of an anti-adhesive agent, 0.2 part by weight of a leveling agent, 0.2 part by weight of an anti-yellowing agent, and 60 parts by weight of DMF were mixed together to form a mixture, followed by adjusting viscosity of the mixture in a range of 3000 to 5000 cps. The mixture was distributed on a release film, followed by drying in an oven at 120° C. for 5 to 10 minutes and aging in room temperature so as to form a polyurethane film.

The polyurethane film was examined by Beta Analytic Inc., an ISO-17025 accredited radiocarbon dating lab, via ASTM-D6866-11 and was determined to have 25% of bio-based content. The resultant polyurethane film was subjected to several physical property measurements. The results are listed in Table 2.

TABLE 2

| Physical properties | Result | |
|---|---|---|
| Moisture permeability | >100,000 g/m² × 24 hr | |
| Water pressure resistance | >10,000 | mm/H₂O |
| 100% Modulus | 40 ± 10 | kgf/cm² |
| Tensile strength | >200 | kgf/cm² |

| | |
|---|---|
| Elongation rate (%) | >300 |

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A polyurethane article, comprising at least 25% of bio-based content and made of a reactive composition containing an isocynate compound, a polymeric polyol component including biomass derived polymeric polyol, and a biomass derived diol.

2. The polyurethane article as claimed in claim 1, wherein said reactive composition includes, based on the total weight of said reactive composition, 35 wt % to 36 wt % of said isocynate compound, 52 wt % to 59 wt % of said polymeric polyol component, and 8 wt % to 10 wt % of said biomass derived diol.

3. The polyurethane article as claimed in claim 2, wherein said polymeric polyol component includes 17 wt % to 20 wt % of said biomass derived polymeric polyol based on the total weight of said reactive composition.

4. The polyurethane article as claimed in claim 3, wherein said polymeric polyol component further includes 35 wt % to 39 wt % of polyethylene glycol that is based on the total weight of said reactive composition and that has a molecular weight ranging from 3000 to 6000.

5. The polyurethane article as claimed in claim 2, wherein said biomass derived diol is ethylene glycol.

6. The polyurethane article as claimed in claim 2, wherein said biomass derived diol includes more than 95 wt % of ethylene glycol, and less than 5 wt % of at least one of propanediol and butanediol based on the weight of said biomass derived diol.

7. The polyurethane article as claimed in claim 1, wherein said biomass derived polymeric polyol has a molecular weight ranging from 1000 to 2400.

8. The polyurethane article as claimed in claim 7, wherein said biomass derived polymeric polyol is selected from a group consisting of polypropylene glycol, poly(propylene glycol adipate) diol, and the combination thereof.

9. The polyurethane article as claimed in claim 1, wherein said isocynate compound is methyl diphenyl diisocyanate.

10. The polyurethane article as claimed in claim 1, which is configured as a film.
